(19) United States
(12) Patent Application Publication
(10) Pub. No.: US 2026/0088877 A1
(43) Pub. Date: Mar. 26, 2026

(54) TECHNOLOGIES FOR ADVANCED CHANNEL STATE INFORMATION PROCESSING CAPABILITY

(71) Applicant: Apple Inc., Cupertino, CA (US)

(72) Inventors: Haitong Sun, Saratoga, CA (US); Ankit Bhamri, Haar (DE); Dawei Zhang, Saratoga, CA (US); Hong He, San Jose, CA (US); Huaning Niu, San Jose, CA (US); Ismael Gutierrez Gonzalez, San Jose, CA (US); Wei Zeng, Saratoga, CA (US)

(73) Assignee: Apple Inc., Cupertino, CA (US)

(21) Appl. No.: 19/309,469

(22) Filed: Aug. 25, 2025

Related U.S. Application Data
(60) Provisional application No. 63/699,065, filed on Sep. 25, 2024.

(51) Int. Cl. H04B 7/06; H04W 24/10; H04W 72/0446

(52) U.S. Cl. CPC H04B 7/0626; H04W 24/10; H04W 72/0446

(57) ABSTRACT

The present application relates to devices and components including apparatus, systems, and methods for advanced channel state information processing capabilities.

### CROSS-REFERENCE TO RELATED APPLICATION

This application claims the benefit of U.S. Provisional Ser. No. 63/699,065, filed on Sep. 25, 2024, which is herein incorporated by reference in its entirety for all purposes.

### TECHNICAL FIELD

This application relates generally to communication networks and, in particular, to technologies for advanced channel state information processing capability.

### BACKGROUND

Third Generation Partnership Project (3GPP) Technical Specifications (TSs) define standards for wireless networks. These TSs describe aspects related to signaling traffic through systems that incorporate wireless networks.

### BRIEF DESCRIPTION OF THE DRAWINGS

FIG. 1 illustrates a network environment in accordance with some embodiments.

FIG. 2 illustrates a procedure in accordance with some embodiments.

FIG. 3 illustrates a signaling diagram in accordance with some embodiments.

FIG. 4 illustrates another signaling diagram in accordance with some embodiments.

FIG. 5 illustrates another signaling diagram in accordance with some embodiments.

FIG. 6 illustrates another signaling diagram in accordance with some embodiments.

FIG. 7 illustrates another signaling diagram in accordance with some embodiments.

FIG. 8 illustrates an operation flow/algorithmic structure in accordance with some embodiments.

FIG. 9 illustrates another operation flow/algorithmic structure in accordance with some embodiments.

FIG. 10 illustrates a user equipment in accordance with some embodiments.

FIG. 11 illustrates a network device in accordance with some embodiments.

### DETAILED DESCRIPTION

The following detailed description refers to the accompanying drawings. The same reference numbers may be used in different drawings to identify the same or similar elements. In the following description, for purposes of explanation and not limitation, specific details are set forth such as particular structures, architectures, interfaces, and techniques in order to provide a thorough understanding of the various aspects of various embodiments. However, it will be apparent to those skilled in the art having the benefit of the present disclosure that the various aspects of the various embodiments may be practiced in other examples that depart from these specific details. In certain instances, descriptions of well-known devices, circuits, and methods are omitted so as not to obscure the description of the various embodiments with unnecessary detail. For the purposes of the present document, the phrases “A/B” and “A or B” mean (A), (B), or (A and B); and the phrase “based on A” means “based at least in part on A,” for example, it could be “based solely on A” or it could be “based in part on A.”

The following is a glossary of terms that may be used in this disclosure.

The term “circuitry” as used herein refers to, is part of, or includes hardware components that are configured to provide the described functionality. The hardware components may include an electronic circuit, a logic circuit, a processor (shared, dedicated, or group) or memory (shared, dedicated, or group), an application specific integrated circuit (ASIC), a field-programmable device (FPD) (e.g., a field-programmable gate array (FPGA), a programmable logic device (PLD), a complex PLD (CPLD), a high-capacity PLD (HCPLD), a structured ASIC, or a programmable system-on-a-chip (SoC)), or a digital signal processor (DSP). In some embodiments, the circuitry may execute one or more software or firmware programs to provide at least some of the described functionality. The term “circuitry” may also refer to a combination of one or more hardware elements (or a combination of circuits used in an electrical or electronic system) with the program code used to carry out the functionality of that program code. In these embodiments, the combination of hardware elements and program code may be referred to as a particular type of circuitry.

The term “processor circuitry” as used herein refers to, is part of, or includes circuitry capable of sequentially and automatically carrying out a sequence of arithmetic or logical operations, or recording, storing, or transferring digital data. The term “processor circuitry” may refer an application processor, baseband processor, a central processing unit (CPU), a graphics processing unit, a single-core processor, a dual-core processor, a triple-core processor, a quad-core processor, or any other device capable of executing or otherwise operating computer-executable instructions, such as program code, software modules, or functional processes.

The term “interface circuitry” as used herein refers to, is part of, or includes circuitry that enables the exchange of information between two or more components or devices. The term “interface circuitry” may refer to one or more hardware interfaces, for example, buses, I/O interfaces, peripheral component interfaces, and network interface cards.

The term “user equipment” or “UE” as used herein refers to a device with radio communication capabilities that may allow a user to access network resources in a communications network. The term “user equipment” or “UE” may be considered synonymous to, and may be referred to as, client, mobile, mobile device, mobile terminal, user terminal, mobile unit, mobile station, mobile user, subscriber, user, remote station, access agent, user agent, receiver, radio equipment, reconfigurable radio equipment, or reconfigurable mobile device. Furthermore, the term “user equipment” or “UE” may include any type of wireless/wired device or any computing device including a wireless communications interface.

The term “computer system” as used herein refers to any type interconnected electronic devices, computer devices, or components thereof. Additionally, the term “computer system” or “system” may refer to various components of a computer that are communicatively coupled with one another. Furthermore, the term “computer system” or “system” may refer to multiple computer devices or multiple computing systems that are communicatively coupled with one another and configured to share computing or networking resources.

The term “resource” as used herein refers to a physical or virtual device, a physical or virtual component or asset within a computing or network environment, or a physical or virtual component within, accessible by, or available to an apparatus, circuitry, device, or component. Resources could include, but are not limited to, memory space/usage, processor/CPU time, processor/CPU usage, processor and accelerator loads, hardware time or usage, electrical power, input/output operations, ports or network sockets, channel/link allocations, throughput, or workload units. A “hardware resource” may refer to compute, storage, or networking resources provided by physical hardware elements. A “virtualized resource” may refer to compute, storage, or networking resources provided by virtualization infrastructure to an application, device, or system. The term “communication resource” may refer to resources that are accessible by, or available to, computer devices/systems for transferring information over a channel of a communication network. For example, communication resources may include, but are not limited to, time/frequency resources, code resources, modulation resources, etc. The term “system resources” may refer to any kind of shared entities to provide services, and may include computing or network resources. System resources may be considered as a set of coherent functions, network data objects or services, accessible through a server where such system resources reside on a single host or multiple hosts and are clearly identifiable.

The term “channel” as used herein refers to any transmission medium, either tangible or intangible, which is used to communicate data or a data stream. The term “channel” may be synonymous with or equivalent to “communications channel,” “data communications channel,” “transmission channel,” “data transmission channel,” “access channel,” “data access channel,” “link,” “data link,” “carrier,” “radio-frequency carrier,” or any other like term denoting a pathway or medium through which data is communicated. Additionally, the term “link” as used herein refers to a connection between two devices for the purpose of transmitting and receiving information.

The terms “instantiate,” “instantiation,” and the like as used herein refers to the creation of an instance. An “instance” also refers to a concrete occurrence of an object, which may occur, for example, during execution of program code.

The term “connected” may mean that two or more elements, at a common communication protocol layer, have an established signaling relationship with one another over a communication channel, link, interface, or reference point.

The term “network element” as used herein refers to physical or virtualized equipment or infrastructure used to provide wired or wireless communication network services. The term “network element” may be considered synonymous to or referred to as a networked computer, networking hardware, network equipment, network node, or a virtualized network function.

The term “information element” refers to a structural element containing one or more fields. The term “field” refers to individual contents of an information element, or a data element that contains content. An information element may include one or more additional information elements.

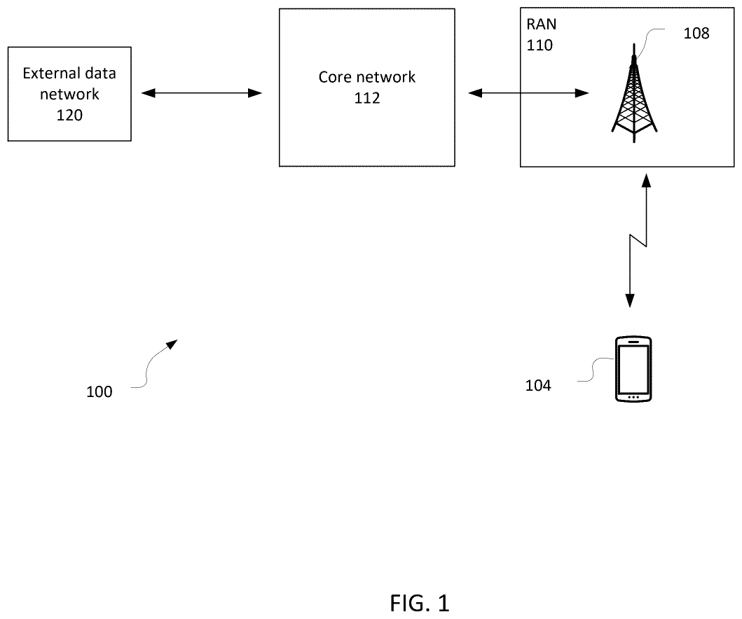

FIG. 1 illustrates a network environment 100 in accordance with some embodiments. The network environment 100 may include a user equipment (UE) 104 communicatively coupled with a base station 108 of a radio access network (RAN) 110. The UE 104 and the base station 108 may communicate over air interfaces compatible with 3GPP TSs such as those that define a Fifth Generation (5G) new radio (NR) system, a Sixth Generation (6G) system, or a later system. The base station 108 may provide user plane and control plane protocol terminations toward the UE 104.

The network environment 100 may further include a core network 112. For example, the core network 112 may comprise a 5G core network (5GC), a 6G core network (6GC), or later generation core network. The core network 112 may be coupled to the base station 108 via a fiber optic or wireless backhaul. The core network 112 may provide functions for the UE 104 via the base station 108. These functions may include managing subscriber profile information, subscriber location, authentication of services, or switching functions for voice and data sessions.

In operation, the base station 108 may transmit downlink reference signals that the UE 104 measures to determine channel state information (CSI). The downlink reference signals may include CSI-reference signals (CSI-RSs) or synchronization signal blocks (SSBs). The CSI may include a channel quality indicator (CQI), a rank indicator (RI), a precoding matrix indicator (PMI), an SSB resource indicator (SSBRI), a CSI-RS resource indicator (CRI), a layer indicator (LI), or layer 1-reference signal receive power (L1-RSRP). The base station 108 may use the CSI to support downlink transmissions on a physical downlink shared channel (PDSCH) and physical downlink control channel (PDCCH).

NR networks support three types of the CSI measurement resources. Periodic CSI measurement resources may include CSI-RS or SSB and may be configured and released by radio resource control (RRC) signaling. Semi-persistent CSI measurement resources may include CSI-RS and may be activated and deactivated by media access control (MAC)-control element (CE). Aperiodic CSI measurement resources may include CSI-RS and may be triggered by downlink control information (DCI).

NR networks support three types of CSI reports; aperiodic CSI reports, semi-persistent CSI reports, and aperiodic CSI reports.

The periodic CSI reports may be carried by a physical uplink control channel (PUCCH). The periodic CSI report may be both configured and released by RRC signaling. The periodic CSI report may rely on periodic measurement resources (for example, CSI-RS or SSB).

A first type of semi-persistent CSI report may also be carried by the PUCCH. The first type of semi-persistent CSI report may be activated and deactivated by MAC-CE. The first type of semi-persistent CSI report may rely on periodic measurement resources (for example, CSI-RS or SSB) or semi-persistent measurement resources (for example, CSI-RS).

A second type of semi-persistent CSI report may be carried by a physical uplink shared channel (PUSCH). The second type of semi-persistent CSI report may be activated and deactivated by DCI. The second type of semi-persistent CSI report may rely on periodic measurement resources (for example, CSI-RS or SSB) or semi-persistent measurement resources (for example, CSI-RS).

The aperiodic CSI report may be carried by the PUSCH and may be triggered by DCI. The aperiodic CSI report may rely on periodic measurement resources (for example, CSI-RS or SSB), semi-persistent measurement resources (for example, CSI-RS), or aperiodic measurement resources (for example, CSI-RS).

CSI processing constraints on the UE 104 may limit the number of CSI reports that the RAN 110 may configure at any time. For example, 3GPP Technical Specification (TS) 38.214 v18.3.0 (2024-07-03) specifies how active CSI-RS resources/ports are to be counted to account for CSI processing complexity.

In any slot, the UE is not expected to have more active CSI-RS ports or active CSI-RS resources in active BWPs than reported as capability. NZP CSI-RS resource is active in a duration of time defined as follows. For aperiodic CSI-RS, starting from the end of the PDCCH containing the request and ending at the end of the scheduled PUSCH containing the report associated with this aperiodic CSI-RS . . . For semi-persistent CSI-RS, starting from the end of when the activation command is applied, and ending at the end of when the deactivation command is applied. For periodic CSI-RS, starting when the periodic CSI-RS is configured by higher layer signalling, and ending when the periodic CSI-RS configuration is released.

If a CSI-RS resource is referred N times by one or more CSI Reporting Settings not configured with higher layer parameter csi-ReportSubConfigToAddModList, the CSI-RS resource and the CSI-RS ports within the CSI-RS resource are counted N times.

TS 38.214, § 5.2.1.6 CSI processing criteria

The UE 104 may report the capability referred to in § 5.2.1.6 by providing a physical (PHY) layer capability report with one or more of the following parameters: a maximum number of simultaneous nonzero power (NZP)-CSI-RS resources per component carrier (CC) (maxNumberSimultaneousNZP-CSI-RS-PerCC); a maximum number of simultaneous NZP-CSI-RS for an active bandwidth part (BWP) across all CCs (maxNumberSimultaneousNZP-CSI-RS-ActBWP-AllCC); a total number of CSI-RS ports in simultaneous CSI-RS resources per CC (totalNumberPortsSimultaneousNZP-CSI-RS-PerCC); and a total number of CSI-RS ports in simultaneous CSI-RS resources in active BWPs across all CCs (totalNumberPortsSimultaneousNZP-CSI-RS-ActBWP-AllCC). The maxNumberSimultaneousNZP-CSI-RS-PerCC and totalNumberPortsSimultaneousNZP-CSI-RS-PerCC parameters may be part of a band NR parameter such as a CSI-RS-interference management (IM) reception for feedback (CSI-RS-IM-ReceptionforFeedback) parameter. The maxNumberSimultaneousNZP-CSI-RS-ActBWP-AllCC and totalNumberPortsSimultaneousNZP-CSI-RS-ActBWP-AllCC parameters may be part of a carrier aggregation (CA) NR parameter such as a CSI-RS-IM reception for feedback per band combination (CSI-RS-IM-ReceptionforFeedbackPerBandComb) parameter. Except as otherwise described herein, the parameters for UE capability signaling may be similar to those described in 3GPP TS 38.306 v18.2.0 (2024-07-11).

For UEs that are capable of more advanced CSI-RS processing, the active CSI-RS resources/ports counting associated with legacy networks may be unnecessarily restrictive. For example, the duration of time defined for the counting may be too relaxed, especially for periodic and semi-persistent CSI-RS. Further, always double counting CSI-RS resource/port when it is referred to multiple times may not be necessary for advanced UEs.

Thus, embodiments describe tightening of active duration and double counting aspects with respect to active CSI-RS resource/port counting for advanced UEs.

Tightening of the active duration used for counting active CSI-RS resources/ports may be described as follows.

For active CSI-RS resource/port counting, the UE 104 may be allowed to report a new capability associated with advanced CSI resource/port counting.

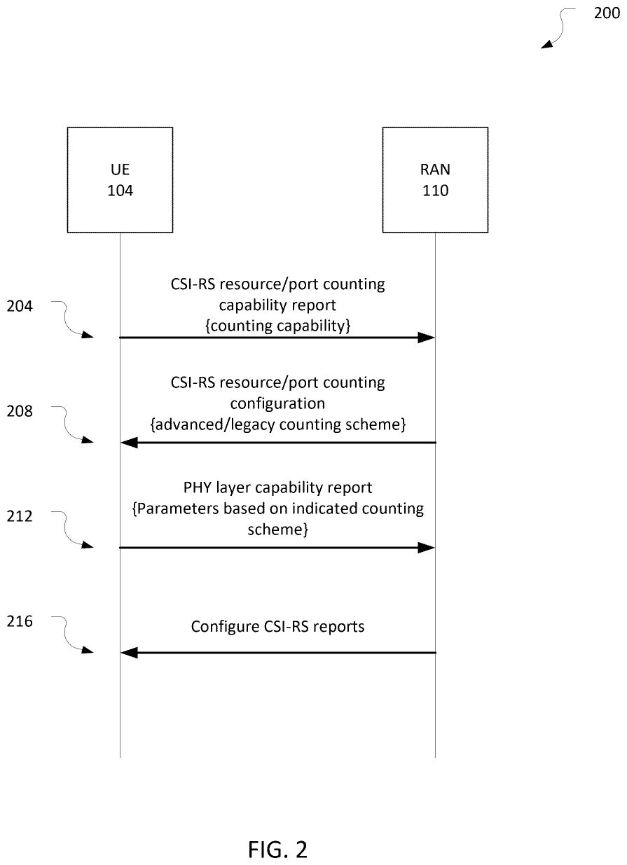

FIG. 2 illustrates a procedure 200 in accordance with some embodiments.

At 204, the procedure 200 may include the UE 104 transmitting a CSI-RS resource/port counting capability report to the RAN 110. The CSI-RS resource/port counting capability report may indicate UE support for different counting schemes for counting active CSI-RS resource/ports in a time domain. The different counting schemes may include different durations for which CSI-RS resources/ports are counted as active. The CSI-RS resource/port counting capability report may provide this indication of UE support as a counting capability. The counting capability may be, for example, a Release (Rel)-19 UE capability, a Rel-18 UE capability, or a Rel-17 UE capability.

In some embodiments, the new counting capability may be reported per UE. Thus, the counting capability provided at 204 may correspond to capabilities of the UE 104. In some instances, this may be provided with an additional granularity with respect to a frequency region or duplexing configuration. For example, the UE 104 may provide a specific counting capability for frequency range (FR)1, FR2-1, or FR2-2. For another example, the UE 104 may provide a specific counting capability for time division duplexing (TDD) or frequency division duplexing (FDD).

In some embodiments, the new counting capability may be reported per band or per band combination (BC).

At 208, the procedure 200 may further include the RAN 110 transmitting a UE CSI-RS resource/port counting configuration to the UE 104 to inform the UE 104 as to which counting scheme is to be used. For example, even if the UE 104 is an advanced UE capable of utilizing an advanced counting scheme as described herein, the RAN 110 may not support the advanced counting scheme or may wish to not use the advanced counting scheme for some reason. Thus, at 208, the RAN 110 may indicate whether the UE 104 is to use the advanced counting scheme or a fall back, legacy counting scheme (such as that described in 3GPP TS 38.214). The configuration provided at 208 may be an RRC configuration.

The procedure 200 may further include, at 212, the UE 104 providing a PHY layer parameter capability report. The PHY layer capability report may include one or more of the parameters that provide a maximum or total number of simultaneous NZP-CSI-RS resources or ports based on an indicated counting scheme. For example, the parameters may include maxNumberSimultaneousNZP-CSI-RS-PerCC, maxNumberSimultaneousNZP-CSI-RS-ActBWP-AllCC, totalNumberPortsSimultaneousNZP-CSI-RS-PerCC, or totalNumberPortsSimultaneousNZP-CSI-RS-ActBWP-AllCC.

The procedure 200 may further include, at 216, the RAN 110 transmitting a message to the UE 104 to configure CSI-RS reports. The configured CSI-RS reports may be within the capabilities of the UE 104 indicated at 212.

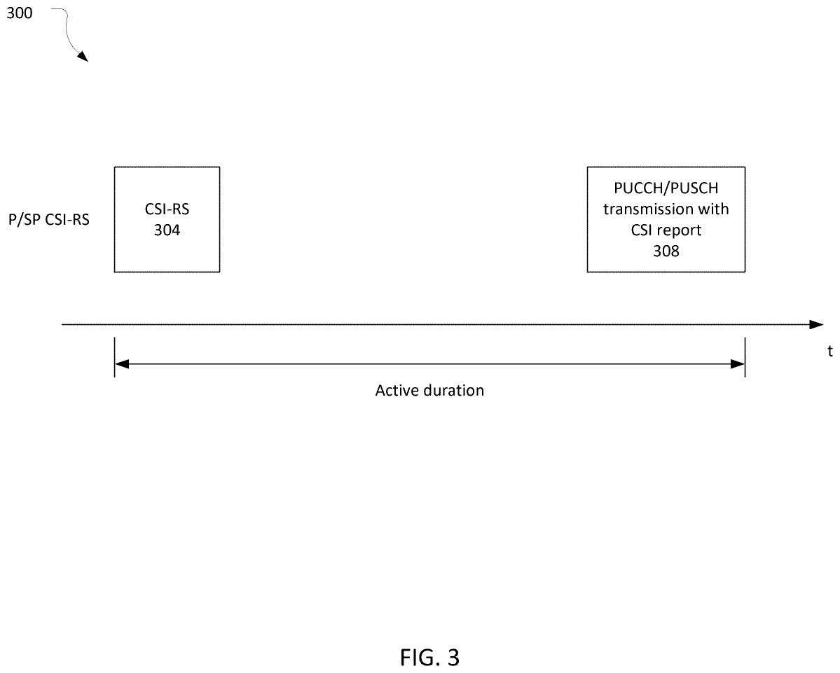

FIG. 3-7 provide signaling diagrams that illustrate active CSI-RS resources/ports counting in accordance with some embodiments. These embodiments may correspond to periodic or semi-persistent CSI-RS and may indicate, among other things, the active durations in which CSI-RS resources/ports are counted as active.

FIG. 3 illustrates a signaling diagram 300 that depicts a first option for active duration tightening in accordance with some embodiments. In the first option, the active duration may start from a beginning (for example, a first symbol) of CSI-RS 304 and extend until a last symbol of a PUCCH/PUSCH transmission with CSI report 308 associated with the CSI-RS 304.

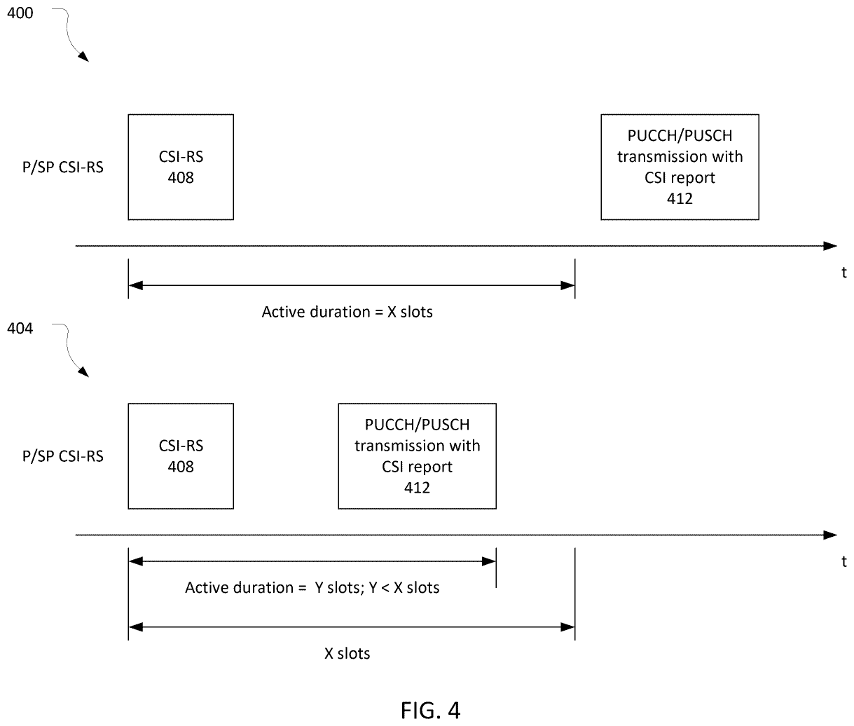

FIG. 4 illustrates signaling diagrams 400 and 404 that depict a second option for active duration tightening in accordance with some embodiments.

With reference to signaling diagram 400, the active duration may start from a beginning (for example, a first symbol) of CSI-RS 408 and extend for a predetermined number (X) of consecutive slots. The predetermined number (X) may be reported as a UE capability or hardcoded in a 3GPP TS.

With reference to signaling diagram 404, in the event X consecutive slots extends beyond the PUCCH/PUSCH transmission with CSI report 412, the extended portion of the active duration may be omitted. Thus, in this instance, the active duration may end at a last symbol of the PUCCH/PUSCH transmission with CSI report 412 and be Y slots, where Y is less than X.

In determining the CSI-RS resource(s) to be counted within the active duration, the concept of a CSI reference resource may be used. The CSI reference resource may be similar to that defined in § 5.2.2.5 of 3GPP TS 38.214. The CSI reference resource is used to define a latest time that a network can transmit a CSI-RS for a particular CSI report. This may be based on processing capabilities of the UE 104. For a particular CSI report, CSI-RS transmitted after the CSI-reference resource cannot be used for measurement. Thus, in some embodiments, for advanced active CSI-RS resource/port counting, for periodic or semi-persistent CSI-RS, for each CSI report carried by a PUCCH/PUSCH transmission, only the latest CSI-RS resource that occurs no later than the corresponding CSI reference resources is counted as active CSI-RS resource/port(s).

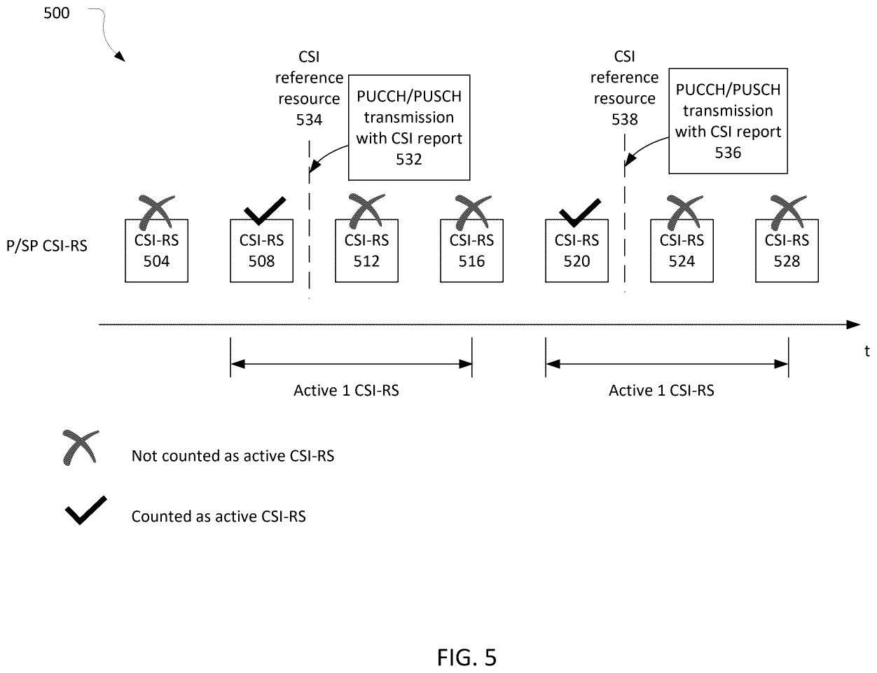

FIG. 5 illustrates a signaling diagram 500 depicting active CSI-RS resources/ports counting in accordance with some embodiments. The signaling diagram includes CSI-RSs 504, 508, 512, 516, 520, 524, and 528. The signaling diagram 500 also includes PUCCH/PUSCH transmission with CSI report 532 associated with CSI-RS 508 and CSI reference resource 534; and PUCCH/PUSCH transmission with CSI report 536 associated with CSI-RS 520 and CSI reference resource 538.

A first active duration may be defined to start at the beginning of CSI-RS 508 and end at an end of the PUCCH/PUSCH transmission with CSI report 532. While the first active duration includes both CSI-RS 508 and CSI-RS 512, only the latest CSI-RS resource that occurs no later than CSI reference resource 534 is counted as an active CSI-RS resource/port(s), that is CSI-RS 508 is counted as the active CSI-RS resource/port(s).

A second active duration may be defined to start at the beginning of CSI-RS 520 and end at an end of the PUCCH/PUSCH transmission with CSI report 536. While the second active duration includes both CSI-RS 520 and CSI-RS 524, only the latest CSI-RS resource that occurs no later than CSI reference resource 534 is counted as active CSI-RS resource/port(s), that is CSI-RS 520 is counted as the active CSI-RS resource/port(s).

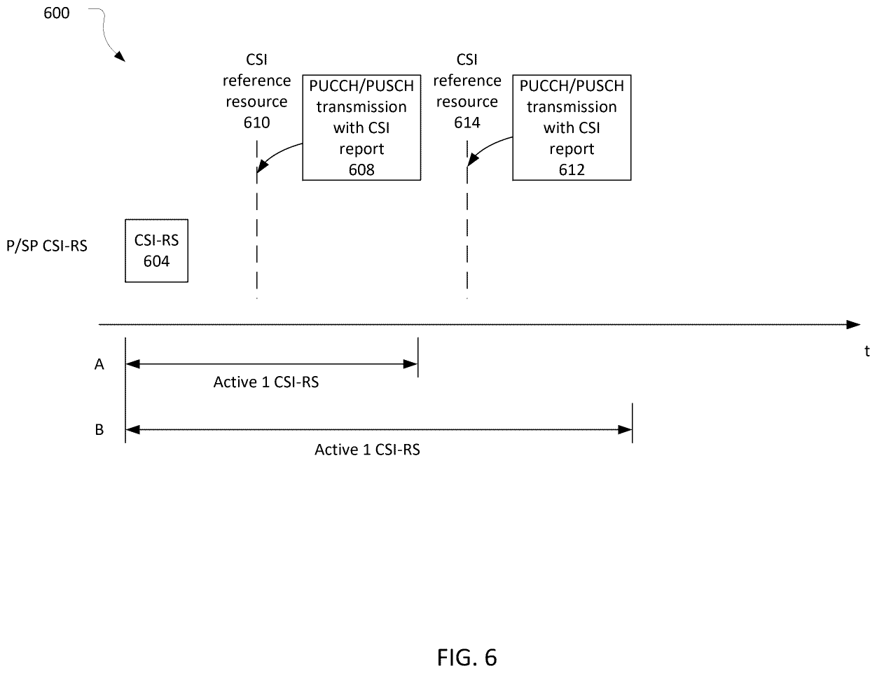

FIG. 6 illustrates a signaling diagram 600 depicting active CSI-RS resource/port counting in accordance with some embodiments. Similar to the above embodiments, the signaling diagram 600 describes advanced active CSI-RS resource/port counting, for periodic or semi-persistent CSI-RS, for each CSI report carried by PUCCH/PUSCH, when only the latest CSI-RS resource that occurs no later than the corresponding CSI reference resource is counted as active CSI-RS resource/port(s). However, in signaling diagram 600, the same CSI-RS resource is selected as the latest CSI-RS resource for N>1 CSI reports carried by PUCCH/PUSCH. In particular, the signaling diagram 600 includes CSI-RS 604 being associated with both PUCCH/PUSCH transmission with CSI report 608 and PUCCH/PUSCH transmission with CSI report 612. The PUCCH/PUSCH transmission with CSI report 608 may be associated with a CSI reference resource 610. The PUCCH/PUSCH transmission with CSI report 612 may be associated with a CSI reference resource 614. In these embodiments, CSI-RS resource/port counting may be performed in accordance with one or more of the following options.

In a first option, active CSI-RS resource/port counting for each CSI report may be counted independently. For example, a first count may be performed for A with respect to CSI-RS 604 and PUCCH/PUSCH transmission with CSI report 608, and a second count may be performed for B with respect to CSI-RS 604 and PUCCH/PUSCH transmission with CSI report 612. Thus, with this option, the CSI-RS 604 may be counted as two active CSI-RS resources.

In a second option, active CSI-RS resource/port counting may only be counted once. In some embodiments, the active CSI-RS resource/port that is counted may be based on the PUCCH/PUSCH transmission that ends the earliest, for example, only A is counted in FIG. 6. In other embodiments, the active CSI-RS resource/port that is counted may be based on the PUCCH/PUSCH transmission that ends last, for example, only B counted in FIG. 6. Counting the CSI-RS 604 as only one active CSI-RS resource/port(s) even though more than one CSI reports are associated with the CSI-RS 604 may be enabled, at least in part, by the UE 104 measuring the CSI-RS 604 once and generating CSI for the multiple CSI reports based on the single measurement.

In some embodiments, whether the CSI-RS 604 is to be counted for each associated CSI report, or is to be counted once for all associated CSI reports may be based on whether the CSI reports include the same CSI report setting (for example, the same CSI report configuration (CSI-ReportConfig)) or different CSI report settings.

For example, if both of the associated CSI reports include the same CSI report setting, the CSI-RS 604 may be counted as an active CSI-RS resource only once and this may be based on, for example, the PUCCH/PUSCH that ends the earliest, for example, only A is counted in FIG. 6.

For another example, if the associated CSI reports include different CSI report settings, active CSI-RS resource/port for each CSI report may be counted independently. For example, both A and B are counted in FIG. 6. In these cases, the underlying measurements performed on CSI-RS 604 may be different for the different reports. Thus, it may be beneficial to count the CSI-RS 604 independently for each CSI report.

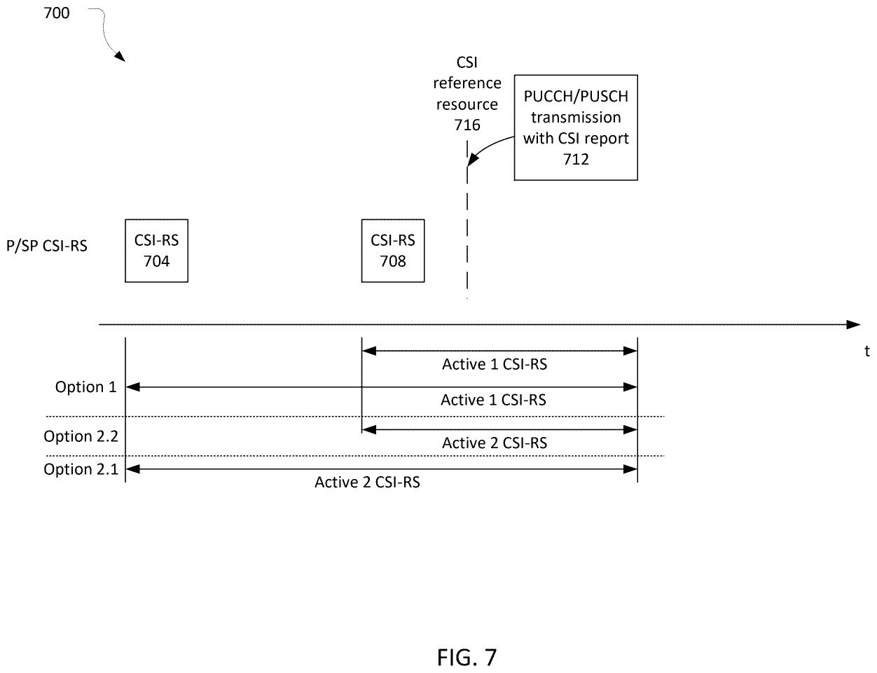

FIG. 7 illustrates a signaling diagram 700 depicting active CSI-RS resources/ports counting in accordance with some embodiments. Similar to the above embodiments, the signaling diagram 700 describes new active CSI-RS resource/port counting, for periodic or semi-persistent CSI-RS, for each CSI report carried by PUCCH/PUSCH when only the latest CSI-RS resource that occurs no later than the corresponding CSI reference is counted as active CSI-RS resources/port(s). However, in signaling diagram 700, the same CSI report is associated with two CSI-RSs. In particular, the signaling diagram 700 includes both CSI-RS 704 and CSI-RS 708 being associated with PUCCH/PUSCH transmission with CSI report 712. The PUCCH/PUSCH transmission with CSI report 712 may be associated with a CSI reference resource 716.

When the same CSI report uses more than one CSI-RS resource, as shown in FIG. 7, each CSI-RS resource/port may be counted independently in terms of the number and, in terms of the timeline, one or more of the following options may be used.

In a first option, Option 1 in FIG. 7, the timelines for each CSI report are determined independently. For example, a first timeline may be provided based on CSI-RS 708 and PUCCH/PUSCH transmission with CSI report 712, and a second timeline may be provided based on CSI-RS 704 and PUCCH/PUSCH transmission with CSI report 712.

In a second option, Option 2 in FIG. 7, a timeline may be jointly determined for the CSI reports. This may be based on the CSI-RS that starts the earliest (for example, CSI-RS 704) as shown in Option 2.1 in FIG. 7. Alternatively, it may be based on the CSI-RS that ends last (for example, CSI-RS 708) as shown in Option 2.2 in FIG. 7.

In some embodiments, the start of the duration during which CSI-RS resources/ports are counted for aperiodic CSI-RS may be determined based on the beginning of the CSI-RS similar to that described with respect to FIG. 3-7 for periodic or semi-persistent CSI-RS. The end of the duration during which CSI-RS resources/ports are counted for aperiodic CSI-RS may correspond to an end of the PUSCH that carries the corresponding CSI report.

In some embodiments, the new active CSI-RS resource/port counting may be used for aperiodic CSI-RS based on the condition that cross-slot aperiodic CSI-RS triggering is configured. Cross-slot aperiodic CSI-RS triggering may be used to avoid the need for the UE 104 to buffer for aperiodic CSI-RS before UE can decode the triggering DCI. Cross-slot aperiodic CSI-RS triggering may be configured by a minimum scheduling offset K0 (minimumSchedulingOffsetK0). This offset may define a minimum distance between the DCI and the associated CSI-RS resource. The minimum scheduling offset may be similar to that described in TS 38.214, for example.

As previously described, NR networks provide that, for active CSI-RS resource/port counting, when CSI-RS resource is referred to multiple times by one or multiple CSI report settings, the same CSI-RS resource is always double counted. See, for example, “[i]f a CSI-RS resource is referred N times by one or more CSI Reporting Settings, the CSI-RS resource and the CSI-RS ports within the CSI-RS resource are counted N times.” TS 38.214.

In some embodiments for active CSI-RS resources/ports counting, the UE 104 is allowed to report new capability to indicate that when a CSI-RS resource is referred multiple times by one or more CSI reporting settings (CSI-ReportConfig), CSI-RS resource is only counted once for active CSI-RS resources/ports. This capability, which may be referred to as a double-counting (DC) capability, may be, for example, a Rel-19 UE capability, a Rel-18 UE capability, or a Rel-17 UE capability.

In some embodiments, the DC capability may be reported per UE. In some instances, the DC capability may be provided with an additional granularity with respect to a frequency region or duplexing configuration. For example, the UE 104 may provide a DC capability for FR1, FR2-1, or FR2-2. For another example, the UE 104 may provide a DC capability for TDD or FDD.

In some embodiments, the DC capability may be reported per band or per band combination (BC).

In some embodiments, the RAN 110 may inform the UE 104 whether DC is used or not.

In some embodiments, double counting may be considered an aspect of a counting scheme and the DC capability may be a type of counting capability exchanged as described above with respect to FIG. 2.

In some embodiments, whether the CSI reporting settings are the same or different may impact whether double counting is to be used for active CSI-RS resources/ports counting. For example, CSI reports associated with the same CSI-RS but having different CSI reporting settings (for example, one is channel measurement resource (CMR) and the other is interference measurement resource (IMR)) may be counted separately. CSI reports associated with the same CSI-RS and having the same CSI reporting settings (for example, both CMR and interference measurement resource (IMR)) may be counted separately.

For example, when a CSI-RS resource is referred to multiple times by one or more CSI reporting settings (CSI-ReportConfigs) as CMR, the CSI-RS resource is only counted once for active CSI-RS resources/ports.

For another example, when a CSI-RS resource is referred to multiple times by one or more CSI reporting settings (CSI-ReportConfigs) as IMR, the CSI-RS resource is only counted once for active CSI-RS resources/ports.

For yet another example, when a CSI-RS resource is referred to a first CSI reporting setting (CSI-ReportConfig) as CMR and a second CSI reporting setting (CSI-ReportConfig) as IMR, the CSI-RS resource is counted twice for active CSI-RS resources/ports.

In some embodiments, the UE 104 may report, in the DC capability, whether it needs separate counting for CMR and IMR.

In some embodiments, whether the CSI reporting settings have the same or different CSI report type (for example, time-domain behavior) may impact whether double counting is to be used for active CSI-RS resources/ports counting. For example, different CSI report types (for example, different time-domain behaviors) may be counted separately. One example is that active CSI-RS resource and ports counting is only relaxed for periodic and/or semi-persistent CSI report, but not relaxed for aperiodic CSI report. The other example is that active CSI-RS resource and ports counting is only relaxed for periodic and/or semi-persistent CSI resource, but not relaxed for aperiodic CSI resource.

For example, when a CSI-RS resource is referred multiple times by one or more aperiodic CSI reporting settings (CSIReportConfigs), the CSI-RS resource is only counted once for active CSI-RS resource/ports.

For another example, when a CSI-RS resource is referred multiple times by one or more periodic or semi-persistent CSI reporting settings (CSI-ReportConfigs), the CSI-RS resource is only counted once for active CSI-RS resource/ports.

For yet another example, when a CSI-RS resource is referred to by an aperiodic CSI reporting setting (CSIReportConfig) and is also referred to by a periodic or semi-persistent CSI reporting setting (CSIReportConfig), the CSI-RS resource is counted twice for active CSI-RS resource/ports.

In some embodiments, the UE 104 may report, in the DC capability, whether it needs separate counting for aperiodic and periodic or semi-persistent reports.

In some embodiments, double counting may be removed only for the CSI-RS referred to multiple times by reports having the same CSI reporting settings. In these cases, the measurements may be very similar and, therefore, double counting may not bee needed. When a CSI-RS resource is referred to multiple times by reports having different CSI reporting settings (CSI-ReportConfigs), the CSI-RS resource may still be double counted.

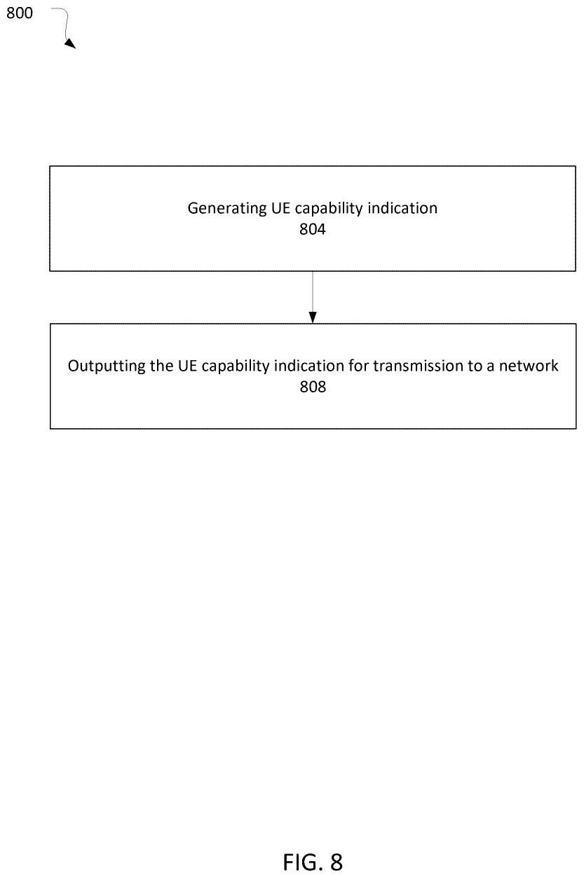

FIG. 8 is an operation flow/algorithmic structure 800 in accordance with some embodiments. The operation flow/algorithmic structure 800 may be implemented by a UE such as, for example, UE 104, UE 1000, or components thereof; for example, a baseband processor 1004A.

The operation flow/algorithmic structure 800 may include, at 804, generating a UE capability indication. The UE capability indication may be a counting/DC indication to indicate support for a counting scheme for counting active CSI-RS resources or ports in a time domain.

In some embodiments, the UE capability indication may indicate support for the counting scheme per UE, band combination, or band. In some embodiments, the UE capability indication may indicate support for the counting scheme per UE and frequency range or division duplexing scheme.

The counting scheme may be any of the counting schemes describe herein. Some examples are provided as follows.

In some embodiments, the counting scheme is a Release 17, 18, or 19 UE capability.

In some embodiments, the counting scheme includes a duration of time for counting active CSI-RS resources or ports that starts at a beginning of a periodic or semi-persistent CSI-RS resource and ends at an end of a PUSCH/PUCCH transmission that carries a CSI report associated with the periodic or semi-persistent CSI-RS.

In some embodiments, the counting scheme includes a duration of time for counting active CSI-RS resources or ports that starts at a beginning of a periodic or semi-persistent CSI-RS resource and ends after a predetermined number of slots.

In some embodiments, the counting scheme includes a duration of time for counting active CSI-RS resources or ports that starts at a beginning of a periodic or semi-persistent CSI-RS resource and ends at whichever occurs first between: an end of a PUSCH/PUCCH transmission that carries a CSI report associated with the periodic or semi-persistent CSI-RS; and a predetermined number of slots.

In some embodiments, the counting scheme provides for counting only one CSI-RS resource as an active CSI-RS resource associated with a CSI report, wherein the one CSI-RS resource is a CSI-RS resource that immediately precedes, in a time domain, a CSI reference resource boundary associated with the CSI report.

In some embodiments, a first CSI report and a second CSI report are both associated with a CSI-RS resource and the counting scheme provides for counting the CSI-RS resource as an active CSI-RS resource based on the first CSI report, but not the second CSI report. The first CSI report may be selected to serve as a basis for counting the CSI-RS resource as the active CSI-RS resource based on the first CSI report occurring before or after the second CSI report.

In some embodiments, a first CSI report and a second CSI report are both associated with a CSI-RS resource and the counting scheme provides for counting the CSI-RS resource as an active CSI-RS resource based on both the first CSI report and the second CSI report.

In some embodiments, a first CSI report and a second CSI report are both associated with a CSI-RS resource, the first CSI report has a first CSI report setting, the second CSI report has a second CSI report setting, and the counting scheme depends on whether the first/second report settings are the same. For example, if the settings are the same, the CSI-RS resource may be counted as an active CSI-RS resource based on the first CSI report, but not the second CSI report. If the settings are different, the CSI-RS resource may be counted as an active CSI-RS resource based on both the first CSI report and the second CSI report.

In some embodiments, a CSI report is associated with a first CSI-RS resource and a second CSI-RS resource and the counting scheme provides for counting both the first CSI-RS resource and the second CSI-RS resource as active CSI-RS resources. In these embodiments, the counting scheme may include: a first duration for counting active CSI-RS resources or ports that starts at a beginning of the first CSI-RS and ends at an end of a PUSCH/PUCCH transmission that carries the CSI report; and a second duration for counting active CSI-RS resources or ports that starts at a beginning of the second CSI-RS and ends at an end of a PUSCH or PUCCH transmission that carries the CSI report. Alternatively, the counting scheme may include a first duration for counting active CSI-RS resources or ports that starts at a beginning of a representative CSI-RS and ends at an end of a PUSCH/PUCCH transmission that carries the CSI report, wherein the representative CSI-RS is a first occurring or last occurring CSI-RS of the CSI-RSs that are associated with the CSI report.

In some embodiments, the counting scheme is applied for aperiodic CSI-RS when cross-slot aperiodic CSI-RS triggering is configured. In these embodiments, the counting scheme includes a duration of time for counting active CSI-RS resources or ports that starts at a beginning of an aperiodic CSI-RS resource and ends at an end of a PUSCH/PUCCH transmission that carries a CSI report associated with the aperiodic CSI-RS or a predetermined number of slots after the beginning of the aperiodic CSI-RS resource.

In some embodiments, a first CSI report and a second CSI report are both associated with a CSI-RS resource, the first CSI report has a first CSI report setting, and the second CSI report has a second CSI report setting that is the same as, or different from, the first CSI report setting. In these embodiments, counting scheme may provide for counting the CSI-RS resource as one active CSI-RS resource. In some instances, the CSI-RS resource may be counted as one active CSI-RS resource if both the first CSI report setting and the second CSI report setting: refer to the CSI-RS resource as a CMR; refer to the CSI-RS resource as an IMR; are aperiodic CSI report settings; or are periodic or semi-persistent report settings. In some embodiments, if the first CSI report setting refers to the CSI-RS resource as a CMR and the second CSI report setting refers to the CSI-RS resource as an IMR, the CSI-RS resource may be counted as an active CSI-RS resource based on both the first CSI report and the second CSI report. In some embodiments, if the first CSI report has an aperiodic CSI report setting and the second CSI report has a periodic or semi-persistent CSI report setting, the CSI-RS resource may be counted as an active CSI-RS resource based on both the first CSI report and the second CSI report.

In some embodiments, after providing the UE capability indication, the UE/processor may receive, an indication, from the network, of a selected counting scheme. The selected counting scheme may be the one provided in the UE capability indication or a different one. For example, if the UE capability indication includes an advanced counting scheme, the NW may signal that the UE/processor is to use the advanced counting scheme or a legacy counting scheme.

After receiving the indication of the selected counting scheme, the UE/processor may generate, based on the selected counting scheme, a physical layer capability report to indicate a maximum number of simultaneous nonzero power (NZP)-CSI-RS resources per CC, a maximum a maximum number of simultaneous NZP-CSI-RS for an active BWP across all CCs, a total number of CSI-RS ports in simultaneous CSI-RS resources per CC, or a total number of CSI-RS ports in simultaneous CSI-RS resources in active BWPs across all CCs. The physical layer capability report may be output for transmission to the network.

The operation flow/algorithmic structure 900 may further include, at 908, outputting the UE capability indication for transmission to a network. For example, baseband circuitry may generate a signal to include the UE capability indication and provide the signal to a transmitter for over-the-air transmission to a base station of a RAN.

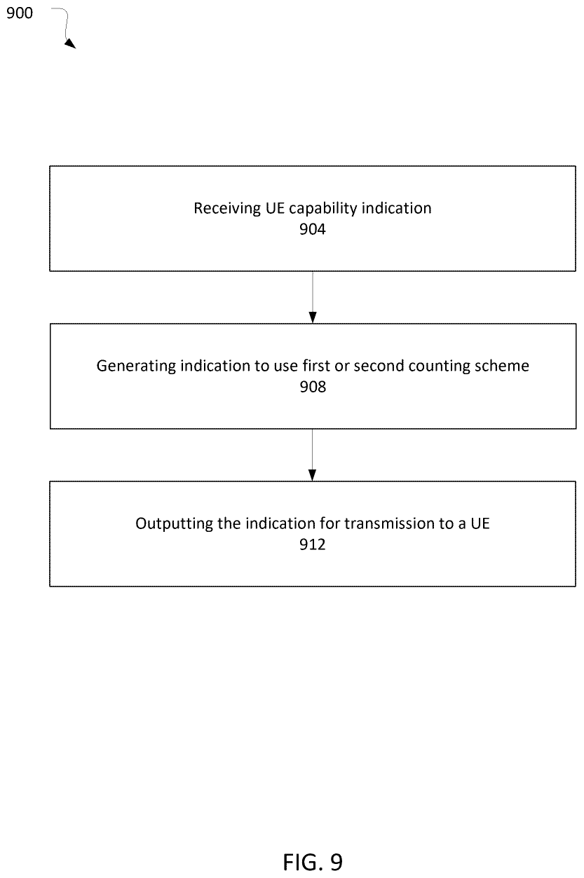

FIG. 9 is an operation flow/algorithmic structure 900 in accordance with some embodiments. The operation flow/algorithmic structure 900 may be implemented by a network node such as, for example, base station 108, network device 1100, or components thereof; for example, a baseband processor 1104A.

The operation flow/algorithmic structure 900 may include, at 904, receiving a UE capability indication. The indication may indicate support for a first counting scheme for counting active channel state information-reference signal (CSI-RS) resources or ports in a time domain. The UE capability indication and counting scheme may be similar to that described with respect to FIG. 8 or elsewhere herein.

The operation flow/algorithmic structure 900 may further include, at 908, generating an indication to use the first counting scheme (reported in the UE capability indication) or a second counting scheme.

The operation flow/algorithmic structure 900 may further include, at 912, outputting the indication for transmission to a UE. The indication may be output as an RRC signal.

In some embodiments, the operation flow/algorithmic structure 900 may further include receiving, from the UE, a physical layer capability report to indicate a maximum number of simultaneous NZP-CSI-RS resources per CC, a maximum a maximum number of simultaneous NZP-CSI-RS for an active BWP across all CCs, a total number of CSI-RS ports in simultaneous CSI-RS resources per CC, or a total number of CSI-RS ports in simultaneous CSI-RS resources in active BWPs across all CCs. The network node/processor may generate configuration information based on the physical layer capability report. The configuration information may configure the UE with a plurality of CSI reports. The configured CSI reports may not exceed the capabilities signaled in the physical layer capability report.

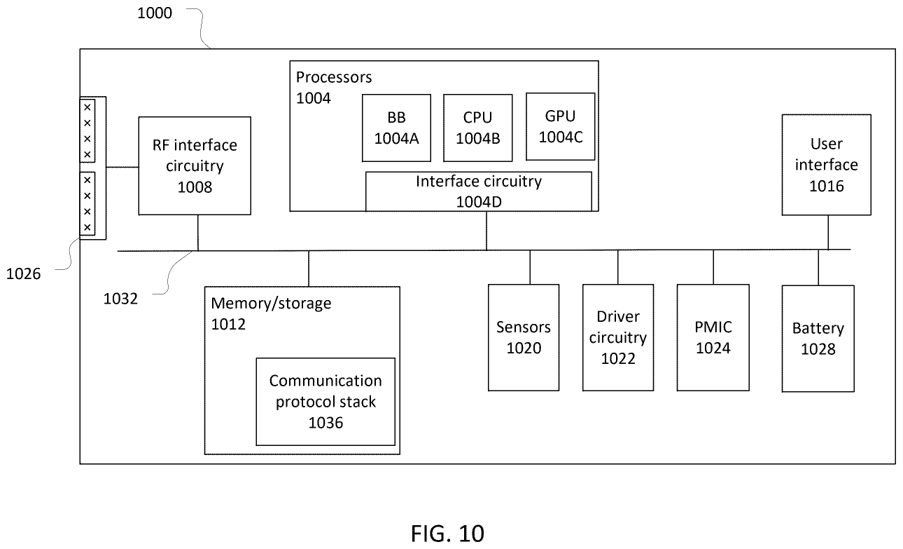

FIG. 10 illustrates a UE 1000 in accordance with some embodiments. The UE 1000 may be similar to and substantially interchangeable with UE 104.

The UE 1000 may be any mobile or non-mobile computing device, such as, for example, mobile phones, computers, tablets, industrial wireless sensors (for example, microphones, carbon dioxide sensors, pressure sensors, humidity sensors, thermometers, motion sensors, accelerometers, laser scanners, fluid level sensors, inventory sensors, electric voltage/current meters, or actuators), video surveillance/monitoring devices (for example, cameras or video cameras), wearable devices (for example, a smart watch), or Internet-of-things devices.

The UE 1000 may include processors 1004, RF interface circuitry 1008, memory/storage 1012, user interface 1016, sensors 1020, driver circuitry 1022, power management integrated circuit (PMIC) 1024, antenna 1026, and battery 1028. The components of the UE 1000 may be implemented as integrated circuits (ICs), portions thereof, discrete electronic devices, or other modules, logic, hardware, software, firmware, or a combination thereof. The block diagram of FIG. 10 is intended to show a high-level view of some of the components of the UE 1000. However, some of the components shown may be omitted, additional components may be present, and different arrangement of the components shown may occur in other implementations.

The components of the UE 1000 may be coupled with various other components over one or more interconnects 1032, which may represent any type of interface, input/output, bus (local, system, or expansion), transmission line, trace, or optical connection that allows various circuit components (on common or different chips or chipsets) to interact with one another.

The processors 1004 may include processor circuitry such as, for example, baseband processor circuitry (BB) 1004A, central processor unit circuitry (CPU) 1004B, and graphics processor unit circuitry (GPU) 1004C. The processors 1004 may include any type of circuitry or processor circuitry that executes or otherwise operates computer-executable instructions, such as program code, software modules, or functional processes from memory/storage 1012 to cause the UE 1000 to perform CSI-RS resource/port counting, configuration, or signaling as described herein. The processors 1004 may also include interface circuitry 1004D to enable communication by, for example, communicatively coupling the processor circuitry with one or more other components of the UE 1000.

In some embodiments, the baseband processor 1004A may access a communication protocol stack 1036 in the memory/storage 1012 to communicate over a 3GPP compatible network. In general, the baseband processor 1004A may access the communication protocol stack 1036 to: perform user plane functions at a PHY layer, MAC layer, RLC layer, PDCP layer, SDAP layer, and PDU layer; and perform control plane functions at a PHY layer, MAC layer, RLC layer, PDCP layer, RRC layer, and a NAS layer. In some embodiments, the PHY layer operations may additionally/alternatively be performed by the components of the RF interface circuitry 1008.

The baseband processor 1004A may generate or process baseband signals or waveforms that carry information in 3GPP-compatible networks. In some embodiments, the waveforms for NR may be based on cyclic prefix OFDM (CP-OFDM) in the uplink or downlink, and discrete Fourier transform spread OFDM (DFT-S-OFDM) in the uplink.

The memory/storage 1012 may include one or more non-transitory, computer-readable media that includes instructions (for example, communication protocol stack 1036) that may be executed by one or more of the processors 1004 to cause the UE 1000 to perform various operations as described herein including, for example, operation flow/algorithmic structure 800 of FIG. 8.

The memory/storage 1012 includes any type of volatile or non-volatile memory that may be distributed throughout the UE 1000. In some embodiments, some of the memory/storage 1012 may be located on the processors 1004 themselves (for example, memory/storage 1012 may be part of a chipset that corresponds to the baseband processor 1004A), while other memory/storage 1012 is external to the processors 1004 but accessible thereto via a memory interface. The memory/storage 1012 may include any suitable volatile or non-volatile memory such as, but not limited to, dynamic random access memory (DRAM), static random access memory (SRAM), erasable programmable read only memory (EPROM), electrically erasable programmable read only memory (EEPROM), Flash memory, solid-state memory, or any other type of memory device technology.

The RF interface circuitry 1008 may include transceiver circuitry and a radio frequency front module (RFEM) that allows the UE 1000 to communicate with other devices over a radio access network. The RF interface circuitry 1008 may include various elements arranged in transmit or receive paths. These elements may include, for example, switches, mixers, amplifiers, filters, synthesizer circuitry, and control circuitry.

In the receive path, the RFEM may receive a radiated signal from an air interface via antenna 1026 and proceed to filter and amplify (with a low-noise amplifier) the signal. The signal may be provided to a receiver of the transceiver that down-converts the RF signal into a baseband signal that is provided to the baseband processor of the processors 1004.

In the transmit path, the transmitter of the transceiver up-converts the baseband signal received from the baseband processor and provides the RF signal to the RFEM. The RFEM may amplify the RF signal through a power amplifier prior to the signal being radiated across the air interface via the antenna 1026.

In various embodiments, the RF interface circuitry 1008 may be configured to transmit/receive signals in a manner compatible with NR access technologies.

The antenna 1026 may include antenna elements to convert electrical signals into radio waves to travel through the air and to convert received radio waves into electrical signals. The antenna elements may be arranged into one or more antenna panels. The antenna 1026 may have antenna panels that are omnidirectional, directional, or a combination thereof to enable beamforming and multiple input, multiple output communications. The antenna 1026 may include microstrip antennas, printed antennas fabricated on the surface of one or more printed circuit boards, patch antennas, or phased array antennas. The antenna 1026 may have one or more panels designed for specific frequency bands including bands in FR1 or FR2.

The user interface 1016 includes various input/output (I/O) devices designed to enable user interaction with the UE 1000. The user interface 1016 includes input device circuitry and output device circuitry. Input device circuitry includes any physical or virtual means for accepting an input including, inter alia, one or more physical or virtual buttons (for example, a reset button), a physical keyboard, keypad, mouse, touchpad, touchscreen, microphones, scanner, headset, or the like. The output device circuitry includes any physical or virtual means for showing information or otherwise conveying information, such as sensor readings, actuator position(s), or other like information. Output device circuitry may include any number or combinations of audio or visual display, including, inter alia, one or more simple visual outputs/indicators (for example, binary status indicators such as light emitting diodes (LEDs) and multi-character visual outputs, or more complex outputs such as display devices or touchscreens (for example, liquid crystal displays (LCDs), LED displays, quantum dot displays, and projectors), with the output of characters, graphics, multimedia objects, and the like being generated or produced from the operation of the UE 1000.

The sensors 1020 may include devices, modules, or subsystems whose purpose is to detect events or changes in their environment and send the information (sensor data) about the detected events to some other device, module, or subsystem. Examples of such sensors include inertia measurement units comprising accelerometers, gyroscopes, or magnetometers; microelectromechanical systems or nanoelectromechanical systems comprising 3-axis accelerometers, 3-axis gyroscopes, or magnetometers; level sensors; flow sensors; temperature sensors (for example, thermistors); pressure sensors; barometric pressure sensors; gravimeters; altimeters; image capture devices (for example, cameras or lensless apertures); light detection and ranging sensors; proximity sensors (for example, infrared radiation detector and the like); depth sensors; ambient light sensors; ultrasonic transceivers; and microphones or other like audio capture devices.

The driver circuitry 1022 may include software and hardware elements that operate to control particular devices that are embedded in the UE 1000, attached to the UE 1000, or otherwise communicatively coupled with the UE 1000. The driver circuitry 1022 may include individual drivers allowing other components to interact with or control various input/output (I/O) devices that may be present within, or connected to, the UE 1000. For example, driver circuitry 1022 may include a display driver to control and allow access to a display device, a touchscreen driver to control and allow access to a touchscreen interface, sensor drivers to obtain sensor readings of sensors 1020 and control and allow access to sensors 1020, drivers to obtain actuator positions of electro-mechanic components or control and allow access to the electro-mechanic components, a camera driver to control and allow access to an embedded image capture device, audio drivers to control and allow access to one or more audio devices.

The PMIC 1024 may manage power provided to various components of the UE 1000. In particular, with respect to the processors 1004, the PMIC 1024 may control power-source selection, voltage scaling, battery charging, or DC-to-DC conversion.

A battery 1028 may power the UE 1000, although in some examples the UE 1000 may be mounted deployed in a fixed location and may have a power supply coupled to an electrical grid. The battery 1028 may be a lithium ion battery, a metal-air battery, such as a zinc-air battery, an aluminum-air battery, a lithium-air battery, and the like. In some implementations, such as in vehicle-based applications, the battery 1028 may be a typical lead-acid automotive battery.

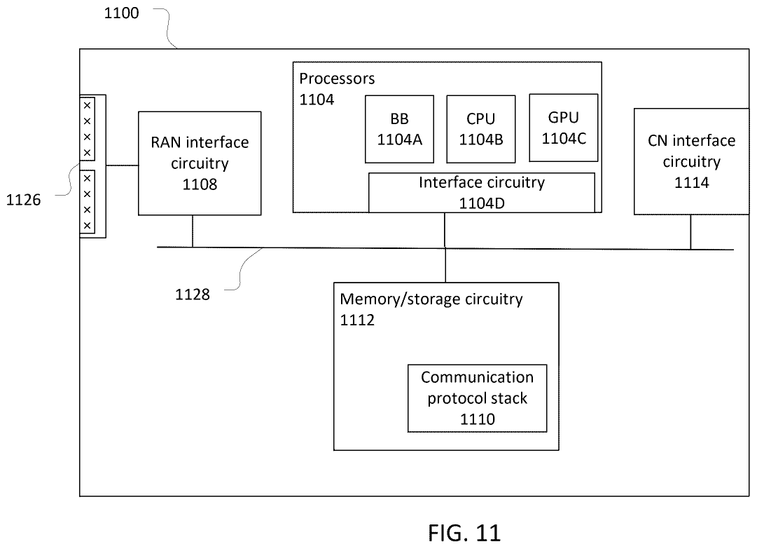

FIG. 11 illustrates a network device 1100 in accordance with some embodiments. The network device 1100 may be similar to and substantially interchangeable with base station 108 or a device of the core network 112 or external data network 120.

The network device 1100 may include processors 1104, RF interface circuitry 1108 (if implemented as a base station), core network (CN) interface circuitry 1114, memory/storage circuitry 1112, and antenna structure 1126.

The components of the network device 1100 may be coupled with various other components over one or more interconnects 1128.

The processors 1104, RF interface circuitry 1108, memory/storage circuitry 1112 (including communication protocol stack 1110), antenna structure 1126, and interconnects 1128 may be similar to like-named elements shown and described with respect to FIG. 11.

The processors 1104 may include processor circuitry such as, for example, baseband processor circuitry (BB) 1104A, central processor unit circuitry (CPU) 1104B, and graphics processor unit circuitry (GPU) 1104C. The processors 1104 may include any type of circuitry or processor circuitry that executes or otherwise operates computer-executable instructions, such as program code, software modules, or functional processes from memory/storage circuitry 1112 to cause the network device 1100 to perform CSI-RS resource/port counting, configuration, or signaling as described herein including, for example, operation flow/algorithmic structure 900 of FIG. 9. The processors 1104 may also include interface circuitry 1104D to enable communication by, for example, communicatively coupling the processor circuitry with one or more other components of the network device 1100.

The CN interface circuitry 1114 may provide connectivity to a core network, for example, a 5^{th} Generation Core network (5GC) using a 5GC-compatible network interface protocol such as carrier Ethernet protocols, or some other suitable protocol. Network connectivity may be provided to/from the network device 1100 via a fiber optic or wireless backhaul. The CN interface circuitry 1114 may include one or more dedicated processors or FPGAs to communicate using one or more of the aforementioned protocols. In some implementations, the CN interface circuitry 1114 may include multiple controllers to provide connectivity to other networks using the same or different protocols.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

For one or more embodiments, at least one of the components set forth in one or more of the preceding figures may be configured to perform one or more operations, techniques, processes, or methods as set forth in the example section below. For example, the baseband circuitry as described above in connection with one or more of the preceding figures may be configured to operate in accordance with one or more of the examples set forth below. For another example, circuitry associated with a UE, base station, or network element as described above in connection with one or more of the preceding figures may be configured to operate in accordance with one or more of the examples set forth below in the example section.

### EXAMPLES

In the following sections, further exemplary embodiments are provided.

Example 1 includes a method comprising: generating a user equipment (UE) capability indication to indicate support for a counting scheme for counting active channel state information-reference signal (CSI-RS) resources or ports in a time domain; and outputting the UE capability indication for transmission to a network.

Example 2 includes the method of example 1 or some other example herein, wherein the UE capability indication is to indicate support for the counting scheme per UE, band combination, or band.

Example 3 includes the method of example 2 or some other example herein, wherein the UE capability indication is to indicate support for the counting scheme per UE and frequency range or division duplexing scheme.

Example 4 includes the method of example 1 or some other example herein, wherein the counting scheme is a first counting scheme and the method further comprises: receiving, from the network via radio resource control signaling, an indication to use the first counting scheme or a second counting scheme for counting active CSI-RS resources or ports in the time domain.

Example 5 includes the method of example 4 or some other example herein, wherein the first counting scheme is a Release 17, 18, or 19 UE capability and the second counting scheme is a Release 15 or 16 UE capability.

Example 6 includes the method of example 1 or some other example herein, wherein the counting scheme includes a duration of time for counting active CSI-RS resources or ports that starts at a beginning of a periodic or semi-persistent CSI-RS resource and ends at an end of a physical uplink shared channel (PUSCH) or physical uplink control channel (PUCCH) transmission that carries a CSI report associated with the periodic or semi-persistent CSI-RS.

Example 7 includes the method of example 1 or some other example herein, wherein the counting scheme includes a duration of time for counting active CSI-RS resources or ports that starts at a beginning of a periodic or semi-persistent CSI-RS resource and ends after a predetermined number of slots.

Example 8 includes the method of example 1 or some other example herein, wherein the counting scheme includes a duration of time for counting active CSI-RS resources or ports that starts at a beginning of a periodic or semi-persistent CSI-RS resource and ends at whichever occurs first between: an end of a physical uplink shared channel (PUSCH) or physical uplink control channel (PUCCH) transmission that carries a CSI report associated with the periodic or semi-persistent CSI-RS; and a predetermined number of slots.

Example 9 includes the method of example 1 or some other example herein, wherein the counting scheme comprises counting only one CSI-RS resource as an active CSI-RS resource associated with a CSI report, wherein the one CSI-RS resource is a CSI-RS resource that immediately precedes, in a time domain, a CSI reference resource boundary associated with the CSI report.

Example 10 includes the method of example 1 or some other example herein, wherein a first CSI report and a second CSI report are both associated with a CSI-RS resource and the counting scheme comprises counting the CSI-RS resource as an active CSI-RS resource based on the first CSI report, but not the second CSI report.

Example 11 includes the method of example 10 or some other example herein, wherein the counting scheme comprises selecting the first CSI report to serve as a basis for counting the CSI-RS resource as the active CSI-RS resource based on the first CSI report occurring before or after the second CSI report.

Example 12 includes the method of example 1 or some other example herein, wherein a first CSI report and a second CSI report are both associated with a CSI-RS resource and the counting scheme comprises counting the CSI-RS resource as an active CSI-RS resource based on both the first CSI report and the second CSI report.

Example 13 includes the method of example 1 or some other example herein, wherein a first CSI report and a second CSI report are both associated with a CSI-RS resource, the first CSI report has a first CSI report setting, the second CSI report has a second CSI report setting, and the counting scheme comprises: determining, based on whether the first CSI report setting is the same as the second CSI report setting, whether to: count the CSI-RS resource as an active CSI-RS resource based on the first CSI report, but not the second CSI report; or count the CSI-RS resource as an active CSI-RS resource based on both the first CSI report and the second CSI report.

Example 14 includes the method of example 1 or some other example herein, wherein a CSI report is associated with a first CSI-RS resource and a second CSI-RS resource and the counting scheme comprises counting both the first CSI-RS resource and the second CSI-RS resource as active CSI-RS resources.

Example 15 includes the method of example 14 or some other example herein, wherein the counting scheme includes: a first duration for counting active CSI-RS resources or ports that starts at a beginning of the first CSI-RS resource and ends at an end of a physical uplink shared channel (PUSCH) or physical uplink control channel (PUCCH) transmission that carries the CSI report; and a second duration for counting active CSI-RS resources or ports that starts at a beginning of the second CSI-RS resource and ends at an end of a PUSCH or PUCCH transmission that carries the CSI report.

Example 16 includes the method of example 14 or some other example herein, wherein the counting scheme includes: a first duration for counting active CSI-RS resources or ports that starts at a beginning of a representative CSI-RS resource and ends at an end of a physical uplink shared channel (PUSCH) or physical uplink control channel (PUCCH) transmission that carries the CSI report, wherein the representative CSI-RS resource is a first occurring or last occurring of the first CSI-RS resource and the second CSI-RS resource.

Example 17 includes the method of example 1 or some other example herein, wherein the counting scheme is applied for aperiodic CSI-RS when cross-slot aperiodic CSI-RS triggering is configured, and the counting scheme includes a duration of time for counting active CSI-RS resources or ports that starts at a beginning of an aperiodic CSI-RS resource and ends at an end of a physical uplink shared channel (PUSCH) that carries a CSI report associated with the aperiodic CSI-RS resource or a predetermined number of slots after the beginning of the aperiodic CSI-RS resource.

Example 18 includes the method of example 1 or some other example herein, wherein a first CSI report and a second CSI report are both associated with a CSI-RS resource, the first CSI report has a first CSI report setting, the second CSI report has a second CSI report setting that is the same as, or different from, the first CSI report setting, and the counting scheme comprises: counting the CSI-RS resource as one active CSI-RS resource.

Example 19 includes the method of example 18 or some other example herein, wherein both the first CSI report setting and the second CSI report setting refer to the CSI-RS resource as a channel measurement resource, or both the first CSI report setting and the second CSI report setting refer to the CSI-RS resource as an interference measurement resource.

Example 20 includes the method of example 18 or some other example herein, wherein both the first CSI report setting and the second CSI report setting are aperiodic CSI report settings, or both the first CSI report setting and the second CSI report setting are periodic or semi-persistent report settings.

Example 21 includes the method of example 1 or some other example herein, wherein a first CSI report and a second CSI report are both associated with a CSI-RS resource, the first CSI report has a first CSI report setting that refers to the CSI-RS resource as a channel measurement resource, the second CSI report has a second CSI report setting that refers to the CSI-RS resource as an interference measurement resource, and the counting scheme comprises: counting the CSI-RS resource as an active CSI-RS resource based on both the first CSI report and the second CSI report.

Example 22 includes the method of example 1 or some other example herein, wherein a first CSI report and a second CSI report are both associated with a CSI-RS resource, the first CSI report has an aperiodic CSI report setting, the second CSI report has a periodic or semi-persistent CSI report setting, and the counting scheme comprises: counting the CSI-RS resource as an active CSI-RS resource based on both the first CSI report and the second CSI report.

Example 23 includes the method of any one of examples 1-22 or some other example herein, further comprising: generating, based on the counting scheme, a physical layer capability report to indicate a maximum number of simultaneous nonzero power (NZP)-CSI-RS resources per component carrier (CC), a maximum a maximum number of simultaneous NZP-CSI-RS resources for an active bandwidth part (BWP) across all CCs, a total number of CSI-RS ports in simultaneous CSI-RS resources per CC, or a total number of CSI-RS ports in simultaneous CSI-RS resources in active BWPs across all CCs; and outputting the physical layer capability report for transmission to the network.

Example 24 includes method comprising: receiving a user equipment (UE) capability indication that indicates support for a first counting scheme for counting active channel state information-reference signal (CSI-RS) resources or ports in a time domain; generating an indication an indication to use the first counting scheme or a second counting scheme for counting active CSI-RS resources or ports in the time domain; and outputting the indication for transmission to a UE.

Example 25 includes the method of example 24 or some other example herein, wherein the UE capability indication is to indicate support for the first counting scheme per UE, band combination, or band.

Example 26 includes the method of example 25 or some other example herein, wherein the UE capability indication is to indicate support for the first counting scheme per UE and frequency range or division duplexing scheme.

Example 27 includes the method of example 24 or some other example herein, further comprising: generating radio resource control signaling to include the indication.

Example 28 includes the method of example 24 or some other example herein, wherein the first counting scheme is a Release 17, 18, or 19 UE capability and the second counting scheme is a Release 15 or 16 UE capability.

Example 29 includes the method of example 24 or some other example herein, wherein the first counting scheme includes a duration of time for counting active CSI-RS resources or ports that starts at a beginning of a periodic or semi-persistent CSI-RS resource and ends at an end of a physical uplink shared channel (PUSCH) or physical uplink control channel (PUCCH) transmission that carries a CSI report associated with the periodic or semi-persistent CSI-RS.

Example 30 includes the method of example 24 or some other example herein, wherein the first counting scheme includes a duration of time for counting active CSI-RS resources or ports that starts at a beginning of a periodic or semi-persistent CSI-RS resource and ends after a predetermined number of slots.

Example 31 includes the method of example 24 or some other example herein, wherein the first counting scheme includes a duration of time for counting active CSI-RS resources or ports that starts at a beginning of a periodic or semi-persistent CSI-RS resource and ends at whichever occurs first between: an end of a physical uplink shared channel (PUSCH) or physical uplink control channel (PUCCH) transmission that carries a CSI report associated with the periodic or semi-persistent CSI-RS; and a predetermined number of slots.

Example 32 include method of example 24 or some other example herein, wherein the first counting scheme comprises counting only one CSI-RS resource as an active CSI-RS resource associated with a CSI report, wherein the one CSI-RS resource is a CSI-RS resource that immediately precedes, in a time domain, a CSI reference resource boundary associated with the CSI report.

Example 33 includes the method of example 24 or some other example herein, wherein a first CSI report and a second CSI report are both associated with a CSI-RS resource and the first counting scheme comprises counting the CSI-RS resource as an active CSI-RS resource based on the first CSI report, but not the second CSI report.

Example 34 includes the method of example 33 or some other example herein, wherein the first counting scheme comprises selecting the first CSI report to serve as a basis for counting the CSI-RS resource as the active CSI-RS resource based on the first CSI report occurring before or after the second CSI report.

Example 35 includes the method of example 24 or some other example herein, wherein a first CSI report and a second CSI report are both associated with a CSI-RS resource and the first counting scheme comprises counting the CSI-RS resource as an active CSI-RS resource based on both the first CSI report and the second CSI report.

Example 36 includes the method of example 24 or some other example herein, wherein a first CSI report and a second CSI report are both associated with a CSI-RS resource, the first CSI report has a first CSI report setting, the second CSI report has a second CSI report setting, and the first counting scheme comprises: determining, based on whether the first CSI report setting is the same as the second CSI report setting, whether to: count the CSI-RS resource as an active CSI-RS resource based on the first CSI report, but not the second CSI report; or count the CSI-RS resource as an active CSI-RS resource based on both the first CSI report and the second CSI report.

Example 37 includes the method of example 24 or some other example herein, wherein a CSI report is associated with a first CSI-RS resource and a second CSI-RS resource and the first counting scheme comprises counting both the first CSI-RS resource and the second CSI-RS resource as active CSI-RS resources.

Example 38 includes the method of example 37 or some other example herein, wherein the counting scheme includes: a first duration for counting active CSI-RS resources or ports that starts at a beginning of the first CSI-RS resource and ends at an end of a physical uplink shared channel (PUSCH) or physical uplink control channel (PUCCH) transmission that carries the CSI report; and a second duration for counting active CSI-RS resources or ports that starts at a beginning of the second CSI-RS resource and ends at an end of a PUSCH or PUCCH transmission that carries the CSI report.

Example 39 includes the method of example 37 or some other example herein, wherein the first counting scheme includes: a first duration for counting active CSI-RS resources or ports that starts at a beginning of a representative CSI-RS resource and ends at an end of a physical uplink shared channel (PUSCH) or physical uplink control channel (PUCCH) transmission that carries the CSI report, wherein the representative CSI-RS resource is a first occurring or last occurring of the first CSI-RS resource and the second CSI-RS resource.

Example 40 includes the method of example 24 or some other example herein, wherein the first counting scheme is applied for aperiodic CSI-RS when cross-slot aperiodic CSI-RS triggering is configured, and the counting scheme includes a duration of time for counting active CSI-RS resources or ports that starts at a beginning of an aperiodic CSI-RS resource and ends at an end of a physical uplink shared channel (PUSCH) that carries a CSI report associated with the aperiodic CSI-RS resource or a predetermined number of slots after the beginning of the aperiodic CSI-RS resource.

Example 41 includes the method of example 24 or some other example herein, wherein a first CSI report and a second CSI report are both associated with a CSI-RS resource, the first CSI report has a first CSI report setting, the second CSI report has a second CSI report setting that is the same as, or different from, the first CSI report setting, and the first counting scheme comprises: counting the CSI-RS resource as one active CSI-RS resource.

Example 42 includes the method of example 41 or some other example herein, wherein both the first CSI report setting and the second CSI report setting refer to the CSI-RS resource as a channel measurement resource, or both the first CSI report setting and the second CSI report setting refer to the CSI-RS resource as an interference measurement resource.

Example 43 includes the method of example 41 or some other example herein, wherein both the first CSI report setting and the second CSI report setting are aperiodic CSI report settings, or both the first CSI report setting and the second CSI report setting are periodic or semi-persistent report settings.

Example 44 includes the method of example 24 or some other example herein, wherein a first CSI report and a second CSI report are both associated with a CSI-RS resource, the first CSI report has a first CSI report setting that refers to the CSI-RS resource as a channel measurement resource, the second CSI report has a second CSI report setting that refers to the CSI-RS resource as an interference measurement resource, and the first counting scheme comprises: counting the CSI-RS resource as an active CSI-RS resource based on both the first CSI report and the second CSI report.

Example 45 includes the method of example 24 or some other example herein, wherein a first CSI report and a second CSI report are both associated with a CSI-RS resource, the first CSI report has an aperiodic CSI report setting, the second CSI report has a periodic or semi-persistent CSI report setting, and the first counting scheme comprises: counting the CSI-RS resource as an active CSI-RS resource based on both the first CSI report and the second CSI report.

Example 46 includes the method of any one of examples 24-45 or some other example herein, further comprising: receiving, from the UE, a physical layer capability report to indicate a maximum number of simultaneous nonzero power (NZP)-CSI-RS resources per component carrier (CC), a maximum a maximum number of simultaneous NZP-CSI-RS for an active bandwidth part (BWP) across all CCs, a total number of CSI-RS ports in simultaneous CSI-RS resources per CC, or a total number of CSI-RS ports in simultaneous CSI-RS resources in active BWPs across all CCs; and generating configuration information based on the physical layer capability report, the configuration information to configure a plurality of CSI reports. Another example may include an apparatus comprising means to perform one or more elements of a method described in or related to any of examples 1-28, or any other method or process described herein.

Another example may include one or more non-transitory computer-readable media comprising instructions to cause an electronic device, upon execution of the instructions by one or more processors of the electronic device, to perform one or more elements of a method described in or related to any of examples 1-28, or any other method or process described herein.

Another example may include an apparatus comprising logic, modules, or circuitry to perform one or more elements of a method described in or related to any of examples 1-28, or any other method or process described herein.

Another example may include a method, technique, or process as described in or related to any of examples 1-28, or portions or parts thereof.

Another example may include an apparatus comprising: one or more processors and one or more computer-readable media comprising instructions that, when executed by the one or more processors, cause the one or more processors to perform the method, techniques, or process as described in or related to any of examples 1-28, or portions thereof.

Another example may include a signal as described in or related to any of examples 1-28, or portions or parts thereof.

Another example may include a datagram, information element, packet, frame, segment, PDU, or message as described in or related to any of examples 1-28, or portions or parts thereof, or otherwise described in the present disclosure.

Another example may include a signal encoded with data as described in or related to any of examples 1-28, or portions or parts thereof, or otherwise described in the present disclosure.

Another example may include a signal encoded with a datagram, IE, packet, frame, segment, PDU, or message as described in or related to any of examples 1-28, or portions or parts thereof, or otherwise described in the present disclosure.

Another example may include an electromagnetic signal carrying computer-readable instructions, wherein execution of the computer-readable instructions by one or more processors is to cause the one or more processors to perform the method, techniques, or process as described in or related to any of examples 1-28, or portions thereof.

Another example may include a computer program comprising instructions, wherein execution of the program by a processing element is to cause the processing element to carry out the method, techniques, or process as described in or related to any of examples 1-28, or portions thereof.

Another example may include a signal in a wireless network as shown and described herein.

Another example may include a method of communicating in a wireless network as shown and described herein.

Another example may include a system for providing wireless communication as shown and described herein.

Another example may include a device for providing wireless communication as shown and described herein.

Any of the above-described examples may be combined with any other example (or combination of examples), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Although the embodiments above have been described in considerable detail, numerous variations and modifications will become apparent to those skilled in the art once the above disclosure is fully appreciated. It is intended that the following claims be interpreted to embrace all such variations and modifications.

What is claimed is:

1. A method comprising:
generating a user equipment (UE) capability indication to indicate support for a counting scheme for counting active channel state information-reference signal (CSI-RS) resources or ports in a time domain; and
outputting the UE capability indication for transmission to a network.

2. The method of claim 1, wherein the UE capability indication is to indicate support for the counting scheme per band combination.

3. The method of claim 1, wherein a first CSI report setting and a second CSI report setting both refer to a CSI-RS resource and the counting scheme comprises:
counting the CSI-RS resource as one active CSI-RS resource.

4. The method of claim 3, wherein the CSI-RS resource is a periodic or semi-persistent CSI-RS resource.

5. The method of claim 3, wherein a first CSI report and a second CSI report are both associated with the CSI-RS resource, the first CSI report has the first CSI report setting, and the second CSI report has the second CSI report setting.

6. The method of claim 5, wherein the first CSI report setting is different from the second CSI report setting.

7. The method of claim 3, wherein both the first CSI report setting and the second CSI report setting refer to the CSI-RS resource as a channel measurement resource, or both the first CSI report setting and the second CSI report setting refer to the CSI-RS resource as an interference measurement resource.

8. The method of claim 3, wherein both the first CSI report setting and the second CSI report setting are aperiodic CSI report settings, or both the first CSI report setting and the second CSI report setting are periodic or semi-persistent report settings.

9. The method of claim 1, wherein the UE capability indication is to indicate support for the counting scheme per UE and frequency range or division duplexing scheme.

10. The method of claim 1, wherein the counting scheme is a first counting scheme and the method further comprises:
receiving, from the network via radio resource control signaling, an indication to use the first counting scheme or a second counting scheme for counting active CSI-RS resources or ports in the time domain.

11. A method of wireless communication, the method comprising:
receiving, from a user equipment (UE), a capability indication that indicates support for a counting scheme for counting active channel state information-reference signal (CSI-RS) resources or ports in a time domain;
generating a configuration; and
outputting the configuration for transmission to a UE.

12. The method of claim 11, wherein the capability indication is to indicate support for the counting scheme per band combination.

13. The method of claim 11, wherein a first CSI report setting and a second CSI report setting both refer to a CSI-RS resource and the counting scheme comprises: counting the CSI-RS resource as one active CSI-RS resource.

14. The method of claim 13, wherein the CSI-RS resource is a periodic or semi-persistent CSI-RS resource.

15. The method of claim 13, wherein a first CSI report and a second CSI report are both associated with the CSI-RS resource, the first CSI report has the first CSI report setting, and the second CSI report has the second CSI report setting.

16. The method of claim 13, wherein the first CSI report setting is different from the second CSI report setting.

17. The method of claim 11, wherein the counting scheme includes a duration of time for counting active CSI-RS resources or ports that starts at a beginning of a periodic or semi-persistent CSI-RS resource and ends at an end of a physical uplink shared channel (PUSCH) or physical uplink control channel (PUCCH) transmission that carries a CSI report associated with the periodic or semi-persistent CSI-RS.

18. At least one non-transitory, computer-readable media having instructions that, when executed, cause processor circuitry to:
generate a user equipment (UE) capability indication to indicate support for a counting scheme for counting active channel state information-reference signal (CSI-RS) resources or ports in a time domain; and
output the UE capability indication for transmission to a network.

19. The at least one non-transitory, computer-readable of claim 18, wherein the UE capability indication is to indicate support for the counting scheme per band combination.

20. The at least one non-transitory, computer-readable of claim 18, wherein a first CSI report setting and a second CSI report setting both refer to a CSI-RS resource and the counting scheme comprises: counting the CSI-RS resource as one active CSI-RS resource.
